(19) United States
(12) Patent Application Publication
(10) Pub. No.: US 2014/0020854 A1
(43) Pub. Date: Jan. 23, 2014

(54) UNLOCKING ASSEMBLY FOR FEEDBACK WINDOW CURTAIN SET

(71) Applicant: Hsien-Te HUANG, Taipei City (TW)

(72) Inventor: Hsien-Te HUANG, Taipei City (TW)

(21) Appl. No.: 13/552,096

(22) Filed: Jul. 18, 2012

(51) Int. Cl. E06B 9/62

(52) U.S. Cl. 160/308

(57) ABSTRACT

An unlocking assembly for a feedback window curtain set, which is applicable for use in a window curtain set provided with a self-rewinding curtain having an automatic and feedback mechanism. When the curtain has been released to its lowermost position, the unlocking assembly for the entire unit unlocks a locking device. Free ends of lower sections of the pull cords pass through the underside of the counterweight pendulum rod to enable the pull cords to add to an unlock travel distance. The displacement length of the unlock travel distance is used to actuate a locking device of a winding unit, which enables unlocking the locked state of the curtain. Accordingly, when the curtain is released to any height, an unlocking operation can be effected at any time that rewinds the entire system, thus avoiding danger from the pull cords being exposed.

### BACKGROUND OF THE INVENTION

(a) Field of the Invention

An unlocking assembly for a feedback window curtain set, which is applicable for use in a window curtain set provided with a self-rewinding curtain having an automatic and feedback mechanism. When the curtain has been released to the lowermost position, the unlocking assembly for the entire unit unlocks a locking device to facilitate rewinding of the curtain under any circumstances, thus ensuring that the pull cords do not endanger young children playing therewith.

(b) Description of the Prior Art

In a window curtain set using a self-rewinding mechanism, the feedback force primarily comes from a winding unit, and the winding unit is able to store energy after the curtain is pulled open through use of an external force. If the curtain needs to be freely released to any height, then a transient fixed position is required, and the fixed position determines whether or not the winding unit rewinds through use of a locking device, thus achieving releasing the curtain to a height in a transient fixed state.

The aforementioned mechanism is especially used in window curtain sets provided with pull cords. During the process of releasing the curtain through use of an external force, the pull cords are used to pull on the winding unit, thereby causing the winding unit to produce a directional rotary motion. During the process, a specified amount of kinetic energy is stored by pulling downward on the pulling cords, which is stored in preparation for the feedback force needed when rewinding the curtain.

If the curtain of the window curtain set provided with pull cords of the prior art is released to the lowermost position, and if at that time, the locking device has just entered a locked state, then because the curtain cannot be released to a lower position, thus, the locking device is unable to achieve the unlock travel distance to release the curtain. Moreover, because of the inability to add to the unlock travel distance, thus, the window curtain set is unable to draw back the curtain.

As for the opening and closing operations for a curtain of an automatic curtain recovery window curtain set, when releasing the curtain, the user applies force by grasping and pulling downward on a counterweight pendulum rod fitted to the lower end of the curtain. When the curtain is at any height within the travel distance, slight restoring of the counterweight pendulum rod causes a locking device to produce a locking effect at the required position and angle, thereby fixing the counterweight pendulum rod at the required height position. In addition, if the user wants to draw back the curtain, then the counterweight pendulum rod is manually operated in an inching downward motion, thereby producing an unlock travel distance that drives the locking device to produce an angular position change, enabling complete unlocking and allowing a winding shaft of the winding unit to freely rewind, thus drawing back the curtain. The unlock travel distance formed by the downward inching motion is an operating condition required for any self-rewinding window curtain set.

The present invention solves the problem of when the window curtain has been released downward to its lowermost limit, and just at that time, the locking device has entered a locked state, then because the lower end of the curtain has reached its lowermost limit, thus, the curtain loses the possibility of any further downward inching motion, and the curtain is unable to effect an unblocking action on the locking device.

Regarding a window curtain set provided with a self-rewinding mechanism that is especially designed with pull cords 11. Referring to FIGS. 1-3, a window curtain set 1 is fitted with a horizontal rail 10, and the horizontal direction of the horizontal rail 10 is established to be a working axial line S. The working axial line S is superimposed in a winding unit 2 and a locking device 4. A winding shaft 20 is conjugate mounted to the periphery of the winding unit 2, thereby enabling the winding shaft 20 to rotate on the working axial line S. The locking device 4 is linked to one end of the winding unit 2, and interference by the locking device 4 is kept away by a centrifugal force function, thus enabling the winding shaft 20 to freely rotate, or achieve a locking restraint from the effect of gravity.

The winding unit 2 is axial center supported by a fixed support shaft 22, one end of which is fixed to a corresponding side of the aforementioned horizontal rail 10. The fixed support shaft 22 is radially fixed, and a stop block 24 is joined to an internal end of the fixed support shaft 22. A reversing stop block 26 is fitted to the other end of the fixed support shaft 22 opposite the stop block 24. A helical spring 23 is fitted between the stop block 24 and the reverse stop block 26, with the two end openings of the helical spring 23 respectively joined thereto.

A hollow core of the reversing stop block 26 is freely mounted on the fixed support shaft 22, whereas a circular exterior 260 mounted on the periphery of the reversing stop block 26 enables a hollow core of a corresponding end of the winding shaft 20 to mount thereon. A hollow core of the other end of the winding shaft 20 mounts on a freewheel 25, and the center of the freewheel 25 is supported by a corresponding side end of the horizontal rail 10 to enable maintaining rotation in accordance with the working axial line S.

An axial end surface joining method is used to form a coaxial linkage of the locking device 4 by an end surface thereof being fixedly joined to the corresponding end surface of the reversing stop block 26. The locking devoice 4 is subjected to a simultaneous change in angular position when the reversing stop block 26 rotates.

The external surface of a rotary cylinder 3 is provided with an external thread 31, and the external thread 31 meshes with a fixed female thread 30 of the interior of the horizontal rail 10. An inner surface of the fixed female thread 30 is provided with threaded teeth 301, thereby enabling the aforementioned external thread 31 to mesh therewith. After the winding shaft 20 causes the rotary cylinder 3 to move, a synchronous rotation of the two is established and forms an axial translation. The travel distance of the translation displacement enables pull cords 11 to be singly wound, and the pull cords 11 are wound on to the external surface of the rotary cylinder 3, and the pull cords 11 are prevented from becoming twisted together or entangled.

A counterweight pendulum rod 5 is fixedly joined to the lower ends of the pull cords 11 through locking end pieces 110.

An insertion cavity 210 of a fixed end 21 is used to confine and thereby render the fixed support shaft 22 immobile. The fixed end 21 is fixed by the corresponding end of the horizontal rail 10. Accordingly, the fixed support shaft 22 is in an immobile state.

Referring to FIG. 2, a longitudinal indent of the external surface of the winding shaft 20 is provided with longitudinal guide grooves 201, and the hollow core of the rotary cylinder 3 is provided with meshing protruding teeth 32 corresponding to the positions of the longitudinal guide grooves 201, thereby enabling a mutual operating relationship between the two to be effected. When rotating, the winding shaft 20 drives the rotary cylinder 3 in accordance with the working axial line S.

Referring to FIG. 1, when rotating, the winding shaft 20 drives and causes the rotary cylinder 3 to rotate. The external thread 31 of the external surface of the rotary cylinder 3 is then subjected to rotary meshing causing inclined pushing by the aforementioned internal threaded teeth 301 on the inner surface of the fixed female thread 30 fixed to the horizontal rail 10, effecting transversal displacement of the rotary cylinder 3. Such displacement enables the wound up pull cord 11 to be vertically positioned in corresponding through holes 101 of the horizontal rail 10. When releasing a curtain 100, the pull cords 11 wound on the external surface of the rotary cylinder 3 are able to be vertically released through the corresponding through holes 101, avoiding friction with the inner surface of the through holes 101 of the upper horizontal rail 10.

During the manual operating process of the user letting down the curtain 100, the pull cords 11 produce a brake force causing an angular change in position in the rotary cylinder 3. The rotary cylinder 3 is subjected to the meshing effect of the longitudinal guide grooves 201 and the meshing protruding teeth 32 as shown in FIG. 2, thereby causing the rotary cylinder 3 to drive and rotate the winding shaft 20. Rotation of the winding shaft 20 drives the reversing stop block 26, and the reversing stop block 26 then twists the opposite end of the helical spring 23. However, because the opposite end of the helical spring 23 is fixed by the stop block 24, thus, the helical spring 23 produces a single end torsional deformation, and such a deformation process stores the kinetic energy resulting from pulling downward on the pull cords 11. The energy thus stored is in preparation for the curtain recovery process.

When the user pulls down on the counterweight pendulum rod 5 to any height, the curtain 100 is locked by the locking device 4, and the locking device 4 locks angular position changes in the winding shaft 20, thereby correspondingly maintaining the height position of the counterweight pendulum rod 5.

Regarding the structural configuration of the locking device 4. Referring to FIG. 3, the locking device 4 comprises a reversing plate 41, the plane surface of which is provided with embedding holes 46. One end surface of the locking device 4 is coaxially joined to the reversing stop block 26. After assembling the reversing plate 41 to the reversing stop block 26, the center portion forms a through hole 40. The exterior of the fixed support shaft 22 is disposedly mounted in the through hole 40, enabling the fixed support shaft 22 to freely rotate.

The embedding holes 46 of the reversing plate 41 enable connecting a swinging stop block 43 therein. One end of the swinging stop block 43 is provided with a shaft hole 431, and a pin rod 44 is pivotal passed therethrough and joined to the position of the embedding hole 46, thereby enabling the swinging stop block 43 to form a pendulum motion with the pin rod 44 serving as the axis. The swinging stop block 43 is provided with a clasping tooth 430 at a free end opposite the shaft hole 431 and configured in the direction of the center of the operating axis. The external surface of a cam 42 is provided with indent portions 420. The center portion of the cam 42 is provided with an emplacement hole 421. The external surface of the fixed support shaft 22 is emplaced in the emplacement hole 421. Joining of the fixed support shaft 22 restricts movement of the fixed support shaft 22, and the cam 42 is fixed at a radial angular position. The indent portions 420 of the cam 42 enable the clasping tooth 430 of the swinging stop block 43 to enter therein. When the clasping tooth 430 enters the indent portion 420, a linkage with the cam 42 is formed through the pin rod 44 structure, causing an unidirectional countercheck that prevents the reversing stop block 26 from rotating. If the clasping tooth 430 and the pin rod 44 become separated from the cam 42, then confinement of the reversing stop block 26 is lost. After a centrifugal action is effected, the reversing stop block 26 is able to freely rotate.

Referring to FIGS. 4-6, which show possible operating states of the locking device 4. Referring first to FIG. 4, wherein the cam 42 is fixed on the fixed support shaft 22, and the reversing stop block 26 is superimposed and homocentrically joined to the reversing plate 41. Rotation of the reversing stop block 26 is in synchronous rotation with that of the reversing plate 41. The plane surface of the reversing plate 41 is connected to the swinging stop block 43 through a pin connection of the pin rod 44. The free end of the swinging stop block 43 is provided with the clasping tooth 430, and the swinging stop block 43 has a specific weight. When the user pulls the curtain 100 causing the counterweight pendulum rod 5 at the lower end thereof to arrive at any horizontal height position, slight restoring of the counterweight pendulum rod 5 causes the free end of the swinging stop block 43 to be subjected to a gravitational effect and drop downward, whereupon the clasping tooth 430 will mesh downward into the indent portion 420 of the cam 42 and knock against the inside surface of the indent portion 420. The reversing stop block 26 is then unable to freely rotate, at which time, the counterweight pendulum rod 5 is at the position of a first horizontal line L1. When the user wants to open the curtain 100, the counterweight pendulum rod 5 is inched downward by manually pulling thereon, causing the counterweight pendulum rod 5 to arrive at the position of a second horizontal line L2, which adds an additional unlock travel distance L0. The unlock travel distance L0 provided by the downward inching motion is used to enable the pull cords 11 to drive the winding shaft 20. The winding shaft 20 then synchronously drives the reversing stop block 41, causing the position of the pin rod 44 to form an arc change in angular position, which enables the angular position of the swinging stop block 43 to form a unlocking angle θ. A change in the unlocking angle θ drives the clasping tooth 430 of the swinging stop block 43 to proceed along the sloped edge of the indent portion 420 of the cam 42 and be lifted toward an outward direction, in which the position of the lift is at least outside the range of a radius R of the cam 42.

Referring to FIG. 6, after the aforementioned unlocking angle θ has formed, the user quickly lets go, at which time, the recovery energy instantaneously actuates a reverse rotation of the winding shaft 20, effecting maximum angular acceleration. Because of the centrifugal effect produced by the weight of the swinging stop block 43, thus, the swinging stop block 43 is outwardly swung open, causing the clasping tooth 430 of the swinging stop block 43 to separate from the peripheral radius R of the cam 42, thereby enabling the reversing plate 41 to turn round. Turning round of the reversing plate 41 enables the winding shaft 20 to effect a winding action on the pull cords 11, thus achieving the objective of winding up the curtain 100. The disclosure above describes the self-rewinding operating mechanism of the present invention.

Referring again to FIG. 4 and FIG. 5, according to the aforementioned design of the window curtain set design, when the curtain 100 has been released to the lowermost limiting position, and the locking device 4 is in a locked state, then further inching downward of the curtain 100 is no longer possible, and adding to the unlock travel distance L0 is no longer possible, as depicted in FIG. 5, thus, the swinging stop block 43 is unable to form the unlocking angle θ, and the clasping tooth 430 of the swinging stop block 43 continues to be restrained by the surface of the indent portion 420 of the cam 42 and unable to produce an unlocking state. Under such circumstances, the user needs to climb to a high position to hand operate and force the winding shaft 20 to rotate, causing the winding shaft 20 to form the unlocking angle θ and become dislodged, whereupon the winding shaft 20 is quickly released, thus enabling the winding shaft 20 to achieve a reverse rotational winding operation of the pull cords 11 as shown in FIG. 6.

### SUMMARY OF THE INVENTION

A primary objective of the present invention lies in providing a window curtain set with pull cords and an automatic recovery mechanism, whereby when the curtain (counterweight pendulum rod) has been released to its lowermost position, the entire unit unlocks a locking device. The window curtain set primarily comprises free ends of lower sections of pull cords passing through a counterweight pendulum rod and protruding out the lower underside of the counterweight pendulum rod, thereby facilitating operation whereby an unlock travel distance can be added to. The operating length of the pull cords is greater than the maximum opening length of the curtain, thus enabling the pull cords to obtain an optimum unlock travel distance. The unlock travel distance enables producing a change in a locking device rotated by a winding shaft to form an unlocking angle and unlock the locking device.

A second objective of the present invention lies in the pull cords being fitted with fastening stops positioned at cord sections of lower portions of slide shuttle holes of the counterweight pendulum rod. The fastening stops enable horizontal adjustment of the curtain, and prevent releasing the curtain to a position that exceeds its limiting length, thereby avoiding surpassing the tension the curtain can withstand and damaging the curtain width, and thus achieving the safety effectiveness that enables avoiding excessive pulling on the pull cords causing the pull cords to entangle limbs.

A third objective of the present invention lies in enabling the pull cords to penetrate the lower underside of the winding shaft and form a closed state, thereby enabling the window curtain set to be installed a low positioned window.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a structural schematic view of a window curtain set provided with an automatic recovery mechanism of the prior art.

FIG. 2 is a relational view depicting connection of a winding shaft of a winding unit to a rotary cylinder of the prior art.

FIG. 3 is a structural schematic view depicting assembly of a locking device of the prior art.

FIG. 4 is a schematic view depicting a locked state of the locking device of the prior art.

FIG. 5 is a schematic view depicting the unlocking operation of the locking device of the prior art.

FIG. 6 is a schematic view depicting operation of the locking device reducing release of the freely released winding shaft of the prior art.

FIG. 7 is a basic schematic structural view of the present invention.

FIG. 7-1 is another schematic view depicting use of a winding unit of the present invention.

FIG. 8 is a schematic view of the arrangement of pull cords according to the present invention.

FIG. 9 is a schematic view depicting operation of the pull cords fitted with fastening stops according to the present invention.

FIG. 10 is another schematic view depicting operation of the pull cords fitted with the fastening stops according to the present invention.

FIG. 11 is a schematic view depicting the present invention fitted with a freewheel augmenting downward pulling.

FIG. 12 is a schematic view depicting the pull cords forming a closed state according to the present invention.

### DETAILED DESCRIPTION OF THE PREFERRED EMBODIMENTS

Regarding the operating principle and detailed description of the present invention, please refer to the description of the diagrams as follows:

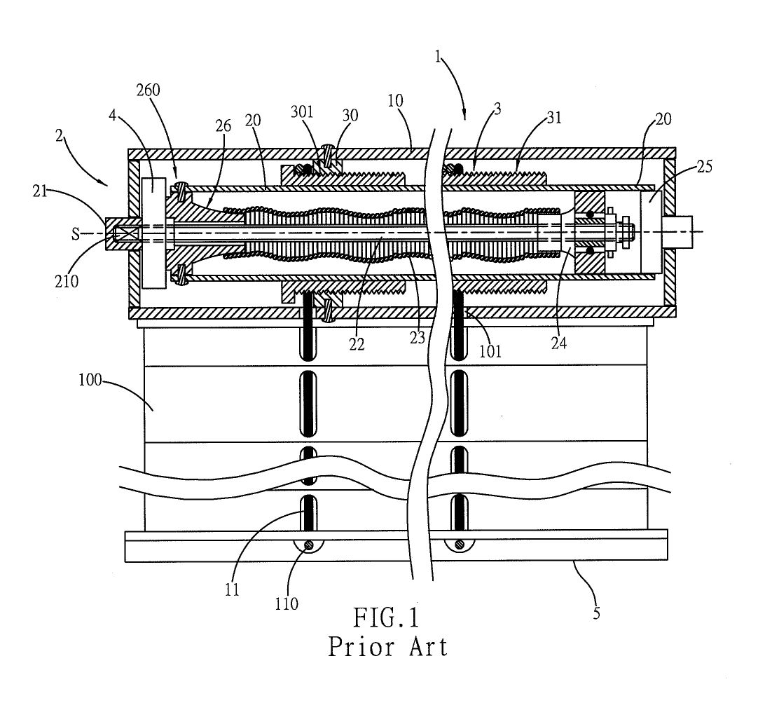

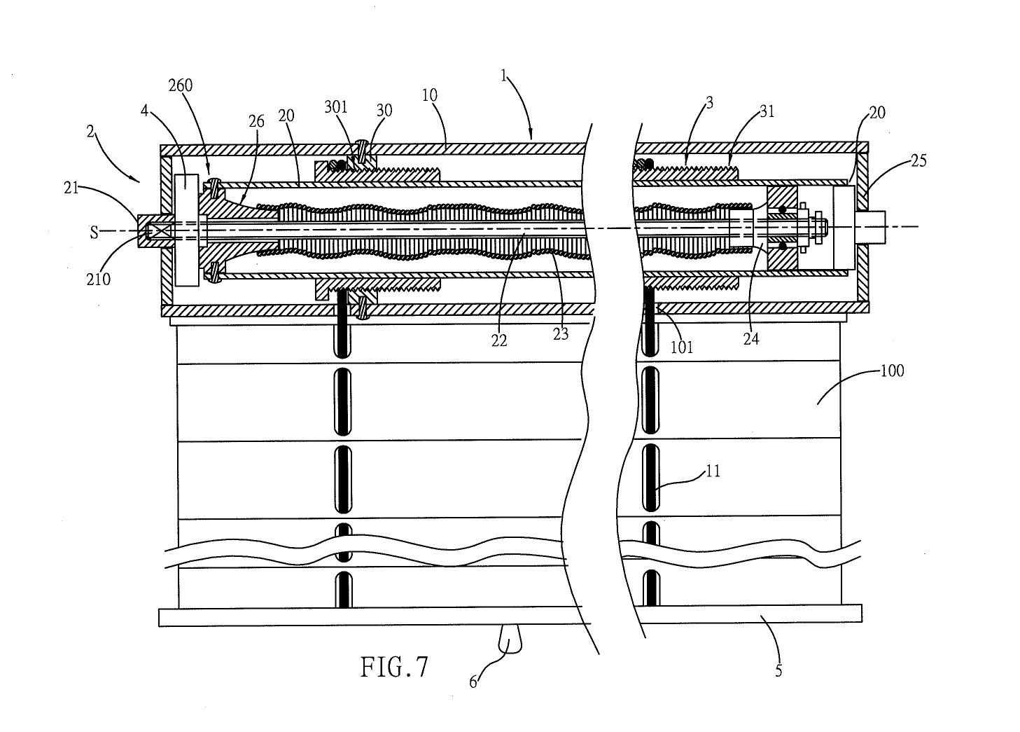

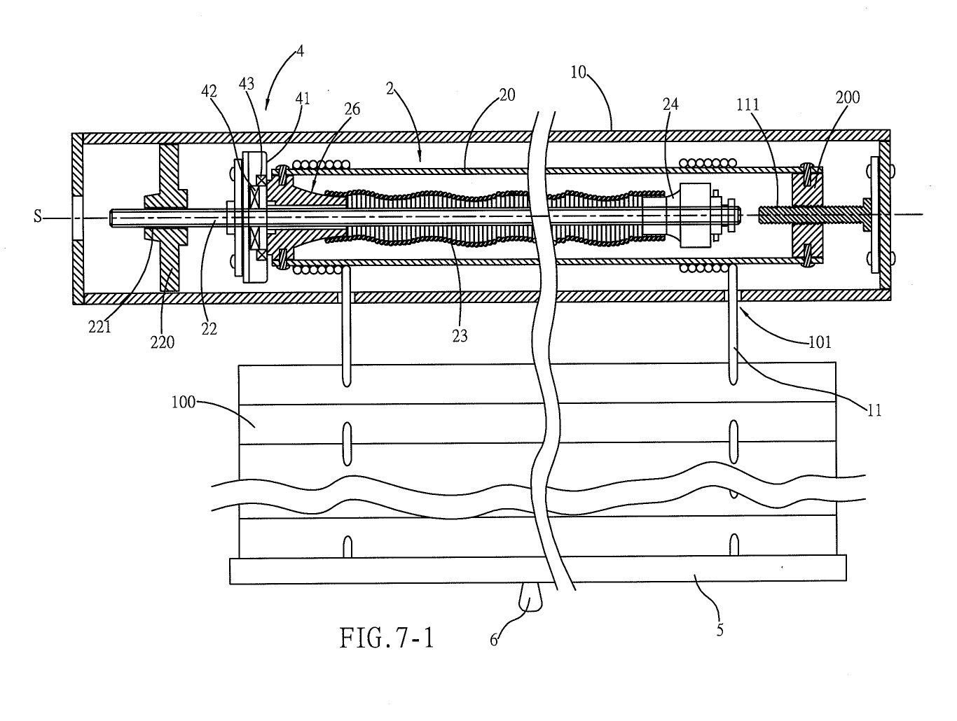

Referring first to FIG. 7 (in conjunction with FIG. 1), the assembly of the present invention comprises a winding unit 2 and a locking device 4 which enable self-rewinding of a curtain 100 of a window curtain set 1 of the prior art. The winding unit 2 is supported by a fixed support shaft 22, one end of which is fixed to a horizontal rail 10 at a side opposite to the winding unit 2, thereby maintaining contrarotation on a working axial line S. A stop block 24 is fitted to the winding unit 2, and the stop block 24 is fixed to an internal end of the fixed support shaft 22. The fixed stop block 24 forms an axial mutual correspondence relative to a reversing stop block 26 through a helical spring 23, effecting a free motion relationship between the reversing stop block 26 and the fixed support shaft 22. The helical spring 23 is fitted between the stop block 24 and the reversing stop block 26, with the two end openings of the helical spring 23 respectively joined thereto. A circular exterior 260 mounted on the periphery of the reversing stop block 26 enables a hollow core of a corresponding end of a winding shaft 20 to mount thereon. A hollow core of another end of the winding shaft 20 is supported to enable movement on the working axial line S movement by a freewheel 25 that is movable disposed on an end of the horizontal rail 10 opposite to the reversing stop block 26.

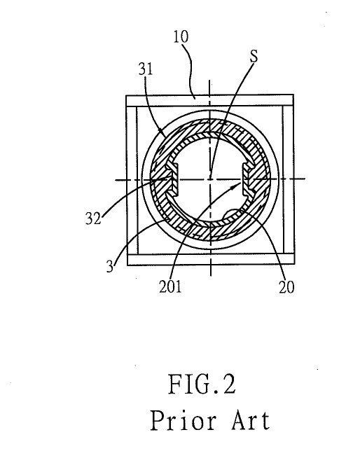

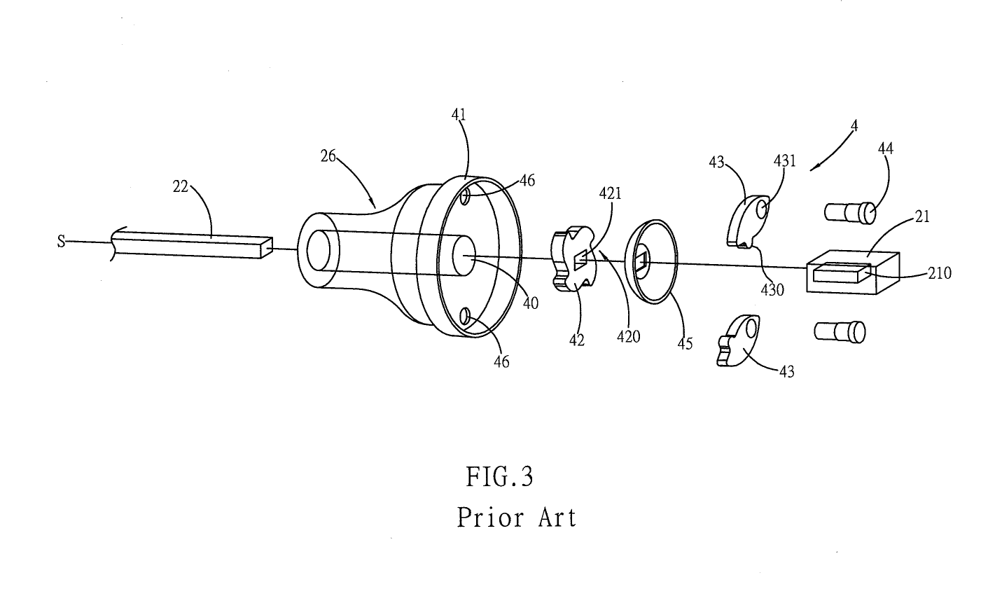

The periphery of the winding shaft 20 is provided with longitudinal guide grooves 201 to effect radial meshing (as depicted in FIG. 2). The longitudinal guide grooves 201 enable the hollow core of a rotary cylinder 3 to be restrained by meshing protruding teeth 32 configured to correspond therewith. When rotating, the winding shaft 20 synchronously drives the rotary cylinder 3 and effects radial contrarotation. The external surface of the rotary cylinder 3 is provided with an external thread 31, which rotary meshes with internal threaded teeth 301 provided on the inner surface of a fixed female thread 30 fixed to the horizontal rail 10. The surface of the external thread 31 of the rotary cylinder 3 enables the cord lengths of pull cords 11 to disposedly wind round thereon, thereby causing the pull cords 11 to rise or fall according to rotation of the rotary cylinder 3.

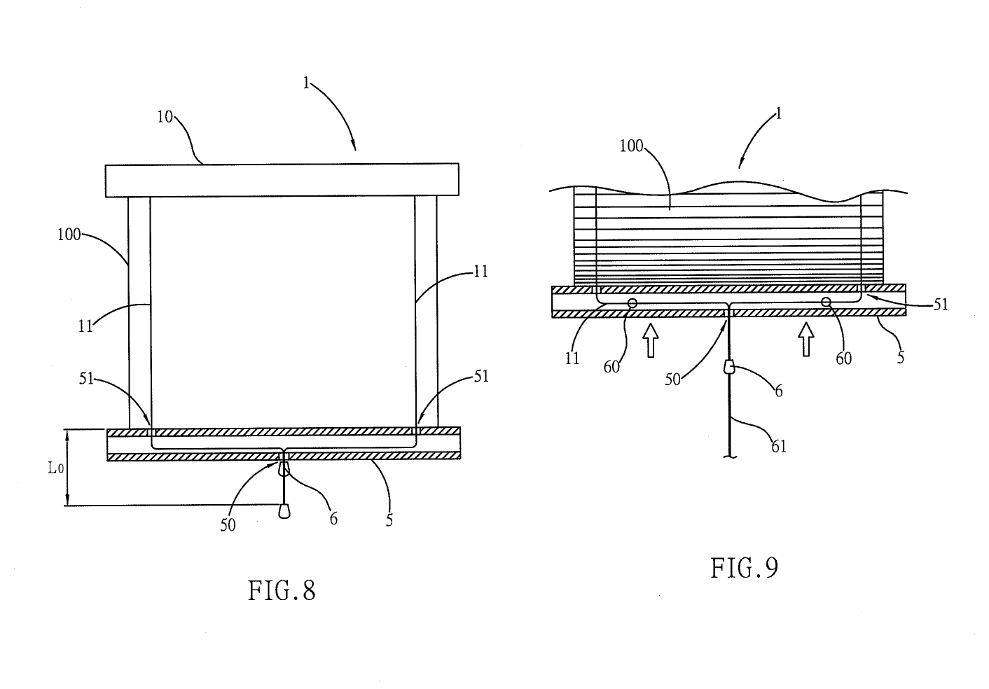

After the pull cords 11 are interweaved through the width of the curtain 100 to form an interlaced relationship therewith, the bottom ends of the pull cords 11 are made to pass through slip holes 51 of a counterweight pendulum rod 5 (as depicted in FIG. 8). The pull cords 11 are made from flexible cord material, and are able to slide through the slip holes 51.

The lower end of the curtain 100 is pulled downward by at least two parallel pull cords 11 on two sides of the curtain 100. The counterweight pendulum rod 5 forms a stop end at the lower end of the curtain 100. The slip holes 51 of the counterweight pendulum rod 5 enable the pull cords 11 to pass therethrough, and the free cord sections that have passed through the slip holes 51 are centrally assembled and tied together, after which the tied free cord sections are made to pass through a centralizing hole 50 of the counterweight pendulum rod 5. The cord ends protruding through the centralizing hole 50 are joined using an unlocking pull tassel 6.

The upper ends of the aforementioned pull cords 11 are wound round the winding shaft 20, in which the total winding length is greater than the length (operating length of the curtain 100) of the curtain 100 released to the lowermost position. Hence, the pull cords 11 are able to be pulled down to a length longer than the operating length, and the extra length is used to add to further downward pulling of an unlock travel distance L0.

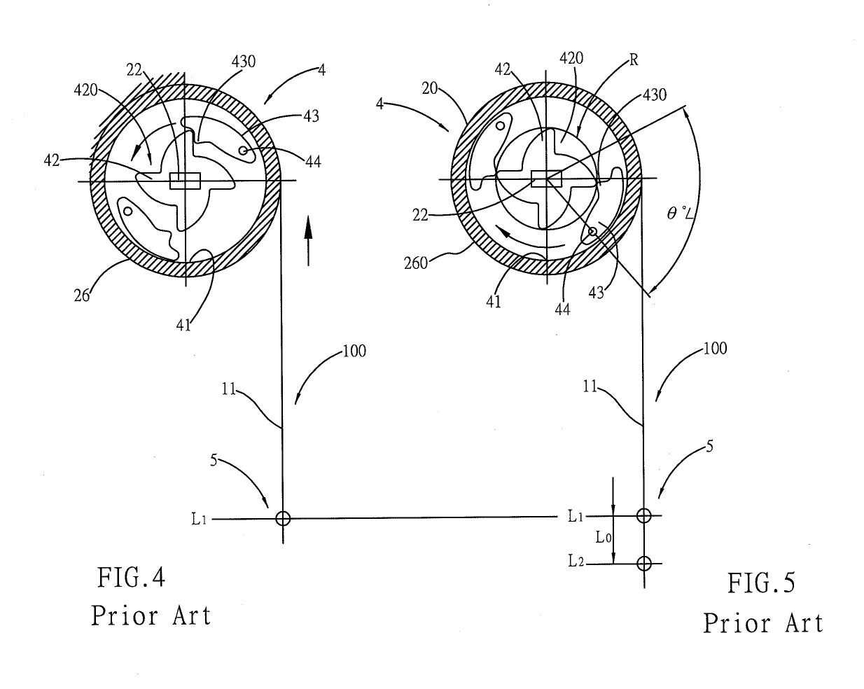

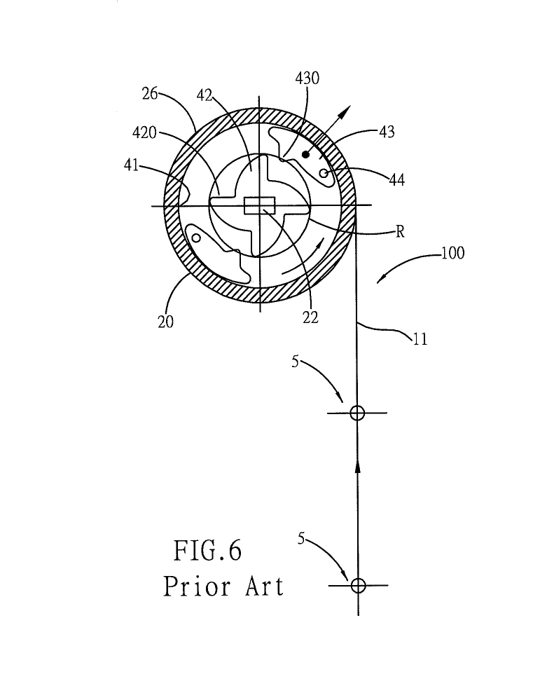

Using the aforementioned structure, when the counterweight pendulum rod 5 of the curtain 100 is released downward to the lowermost extreme position, if the locking device 4 has entered a locked state at that time, as depicted in FIG. 4, then the counterweight pendulum rod 5 is unable to inch downward any further, thus the ability to effect an unlock operation is lost. Under such a situation, the user is able to use the unlocking pull tassel 6 to apply force and pull on the pull cords 11, thereby enabling the pull cords 11 to add to the unlock travel distance L0. The unlock travel distance L0 is used to effect a driving operation, which enables the winding shaft 20 to produce an unlocking angle, as depicted in FIG. 5, causing a clasping tooth 430 of a swinging stop block 43 to separate from an indent portion 420 of a cam 42, to the extent of exceeding the radius R of the cam 42, thereby enabling the system to establish an operating mode, as depicted in FIG. 6, and allow the weight of the swinging stop block 43 to produce a centrifugal force, which causes the clasping tooth 430 to stay outside the range of the radius R of the cam 42, and enables the winding shaft 20 to freely rotate. During the process of winding up the curtain 100, the horizontal rail 10 is able to achieve the objective of unlocking the system under any circumstances.

The interior of the counterweight pendulum rod 5 is hollow, which enables the pull cords 11 to wind round therein and arrive at the centralizing hole 50 after passing through the slip holes 51. The cord ends protruding through the centralizing hole 50 are joined using the unlocking pull tassel 6.

During normal opening of the curtain 100, the user pulls downward on the counterweight pendulum rod 5, and does not move the unlocking pull tassel 6. When the locking device 4 is in the state as depicted in FIG. 4, then the unlocking pull tassel 6 is used to enable a downward pulling action thereon to add to the unlock travel distance L0, thereby enabling the pull cords 11 to achieve an unlocking operation, as depicted in FIG. 5, and further enables the system to achieve a contrarotation movement as depicted in FIG. 6, which causes the winding shaft 20 to smoothly rewind and return the curtain 100.

The aforementioned window curtain set 1 is primarily provided with the pull cords 11 to operate the curtain 100, and is further provided with a self-rewinding feedback system, which is primarily provided by the winding shaft 20. The winding shaft 20 is subjected to feedback rewinding of the helical spring 23, and apart from the aforementioned function effected by the external thread 31 and the fixed female thread 30, as well as the winding and looping configuration of the pull cords 11, the design of the winding unit 2 may also use threads at side ends (as depicted in FIG. 7-1) to actuate the winding shaft 20 to effect horizontal displacement.

Regarding the aforementioned single end actuating operation, the concept behind the design lies in the surface of the winding shaft 20 enabling the upper ends of the pull cords 11 to directly wind round thereon. Hence, apart from the winding shaft 20 relying on the axis of the fixed support shaft 22 to rotate there around, the winding shaft 20 is also further rotatively actuated by a guiding threaded rod 111 in fixed relationship with the horizontal rail 10 on the right side thereof, thereby achieving simultaneous lateral displacement of the winding shaft 20 during the rotating process. The operating mode comprises a capping piece 200 fitted on the right end of the winding shaft 20. The center of the end capping piece 200 is provided with a threaded hole for external teeth of the guiding threaded rod 111 to screw therein. Thus, when the winding shaft 20 is rotating the fixed guiding threaded rod 111 rotates, and the threaded teeth form a lead, which then serves as a lateral displacement force for the winding shaft 20. A change in lateral displacement is then able to accommodate the upper ends of the pull cords 11 winding on the exterior surface of the winding shaft 20, and the wound cords can then be arranged on the same circular surface according to number of winds, enabling the pull cords 11 to pass through through holes 101 in the underside of the horizontal rail 10. The winding unit 2 of the system rotates freely or is located at a closing plate 220 on the left side of the horizontal rail 10. The closing plate 220 is fixedly joined to one end of the fixed support shaft 22 of the winding unit 2, thereby restricting lateral displacement of the fixed support shaft 22. The stop block 24 is fixedly joined to the right end of the fixed support shaft 22, and the stop block 24 is correspondingly joined to the driven reversing stop block 26 indirectly through the helical spring 23. An outer side end drives the reversing plate 41, and an inner end of the reversing plate 41 is fitted to the swinging stop block 43. The swinging stop block 43 effects the cam 42 at the appropriate time, and the fixed support shaft 22 securely fixes the cam 42. The aforementioned fixed support shaft 22 is radially fixed, and the locking device 4 is structured from among the aforementioned reversing plate 41, the swinging stop block 43, and the cam 42.

Regarding the method by which the entire winding unit 2 is able to displace to the right and left, the left end of the fixed support shaft 22 disposedly slides in a through hole 221 of the closing plate 220 (the fixed support shaft 22 has an angular cross-section, and the radial angle is fixed by the hole shape of the through hole 221). Accordingly, after the winding shaft 20 is rotatably actuated in its entirety by the guiding threaded rod 111 and drives the locking device 4 joined to the winding shaft 20, including lateral displacement of the fixed support shaft 22, then a sliding disposition of the left end of the fixed support shaft 22 is effected in the through hole 221 of the closing plate 220, and held the cam 42.

In the aforementioned structural configuration, the pull cords 11 are similarly able to achieve unlocking of the curtain 100 using the unlocking pull tassel 6 of the cord sections connected through the counterweight pendulum rod 5. The system thus similarly enters an unlocking mode, such as that shown in FIG. 7.

The primary objective of the present invention is to resolve the problem of unlocking, which is accomplished with the structure of the winding unit 2 comprising the locking device 4, the winding shaft 20, and the pull cords 11; all of which are implemented in the present invention to achieve the objective.

Referring to FIG. 9, the pull cords 11 are made to pass through the slip holes 51 of the counterweight pendulum rod 5 and transferred to the exterior of the centralizing hole 50. The cord ends protruding after passing through the centralizing hole 50 are joined using the unlocking pull tassel 6. After the unlocking pull tassel 6 centrally draws together the two side pull cords 11, then the cord ends of the pull cords 11 are prevented from wandering toward the slip holes 51. However, the pull cords 11 are made from flexible cord material, and a sliding relationship exists between the pull cords 11 and the slip holes 51. Under any possible exterior action, the levelness of the counterweight pendulum rod 5 will not be affected. Fastening stops 60 are located between the cord sections of the pull cords 11 and the centralizing hole 50 of the slip holes 51. The fastening stops 60 are used to fix the cord sections at fixed points, and the limiting positions of the fastening stops 60 are when they touch the end opening of the slip holes 51, thereby enabling the lengths of the pull cords 11 positioned within the curtain 100 to be fixed. The fastening stops 60 adjustably secure the sections of the pull cords 11, thus, movable adjustment of the fastening stops 60 is used to adjust level correction of the counterweight pendulum rod 5 by adjusting the distance therebetween. In principle, when the lengths of the two side pull cords 11 positioned within the curtain 100 are equal, then the counterweight pendulum rod 5 is maintained horizontal. An extension cord 61 can be made to directly extend from the pull cords 11 at the lower extreme of the unlocking pull tassel 6. When the window curtain set 1 is installed on a high window, the hanging end of the extension cord 61 function to enable the user to stand on the floor and raise their hand to grab the extension cord 61 and effect a pulling operation. Although the pulling force is expended after passing through the sliding motion of the slip hole 51, however, after pulling, lengthening of the pull cords 11 from pulling downward causes the counterweight pendulum rod 5 to fall under its own weight, thereby achieving a downward opening height.

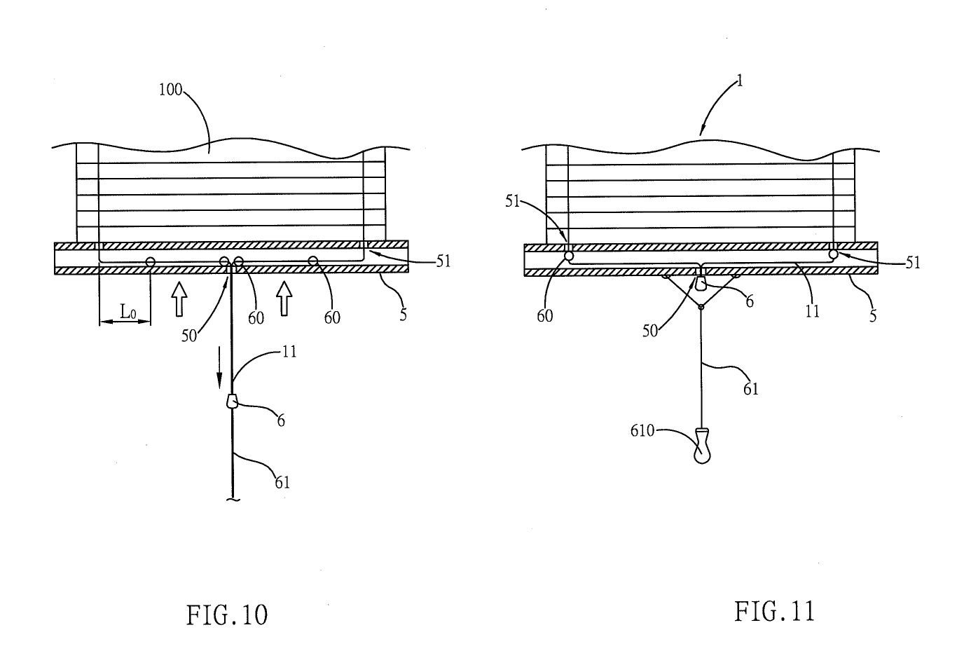

Referring to FIG. 10, after the aforementioned extension cord 61 has been pulled downward, thereby driving the fastening stops 60 toward the centralizing hole 50 and becoming clasped within the end opening of the centralizing hole 50, thus causing the fastening stops 60 to form a wedging pressure that effects the portion of the end opening within the centralizing hole 50 of the counterweight pendulum rod 5. The force of the wedging pressure directly presses on and causes the counterweight pendulum rod 5 to shift downward, and the fastening stops 60 are used to block the internal end of the centralizing hole 50 of the counterweight pendulum rod 5, thereby preventing the pull cords 11 from being pulled down any further, and preventing the pull cords 11 from being excessively pulled outward. The lengths of the pull cords 11 pulled out only need to satisfy the unlock travel distance L0 as depicted in FIG. 5. According to the design specifications of the curtain winding mechanism under normal conditions, the unlock travel distance L0 is within 4 inches or even 2 inches, and even if played with by young children, the pull cords 11 will not entangle their necks and endanger their safety. Hence, the present invention ensures safe usage thereof.

In addition, as for the two fastening stops 60 located on the cord sections of the pull cords 11 between the slip holes 51 and the centralizing hole 50, one of the fastening stops 60 effects the inner end opening of the slip hole 51, and the other fastening stop 60 effects the inner end opening of the centralizing hole 50. Accordingly, the distance between the first fastening stop 60 and the slip hole 51 is the unlock travel distance L0. Hence, the length of the unlock travel distance L0 can be adjusted based on position adjustments of the first fastening stop 60.

Displacement adjustment of the fastening stops 60 located on the aforementioned cord sections of the pull cords 11 between the slip holes 51 and the centralizing hole 50 facilitates achieving adjusting the levelness of the counterweight pendulum rod 5, and prevents the curtain 100 from being excessively pulled downward. At the same time, because the curtain 100 has been prevented from being excessively pulled down, thus, the limbs of young children are safeguarded when playing with the pull cords 11.

Referring to FIG. 11, the aforementioned pull cords 11 of the window curtain set 1 are made to pass through the slip holes 51 of the counterweight pendulum rod 5, then assembled and passed through the centralizing hole 50. The ends of the cord sections protruding through the centralizing hole 50 are joined together using the unlocking pull tassel 6. In special circumstances, the unlocking pull tassel 6 is pulled to add to the unlock travel distance L0 and achieve the unlocking objective as described above. If the window curtain set 1 is installed on a high window, then an append mode can be implemented, whereby the independent extension cord 61 is additionally installed. A pull handle 610 is attached to suspend from the lower portion of the extension cord 61. There is no limit to the length of the extension cord 61. Hence, the user standing below the window curtain set 1 is able to directly pull and cause the counterweight pendulum rod 5 to shift downward by pulling on the independent extension cords 61. The function of the pull handle 610 attached to the extension cord 61 is only to effect downward pulling on the counterweight pendulum rod 5, and is unable to effect an unlocking operation. An unlocking operation is required when the counterweight pendulum rod 5 has already arrived at the lowermost limiting position (that is, already close to the floor), and the curtain 100 can no longer be inched downward any further, then the user is able to pull the pull cords 11 by operating the unlocking pull tassel 6, thereby enabling the pull cords 11 to cause the system to achieve a unlocking angle θ, as depicted in FIG. 5, and achieve a free rewinding operation as shown in FIG. 6.

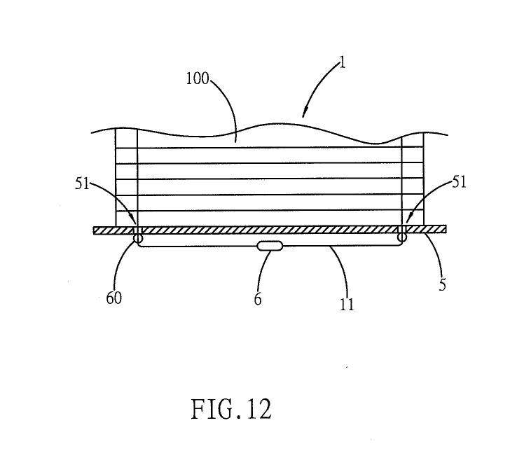

Referring to FIG. 12, the counterweight pendulum rod 5 of the window curtain set 1 of the present invention can be of flat form. The pull cords 11 weave through the curtain 100, and then pass through the slip holes 51 and are turned back along the underside of the counterweight pendulum rod 5 and tied together with the unlocking pull tassel 6 to form a closed state. During normal use, the user grabs and pulls downward on the counterweight pendulum rod 5 to draw open the curtain 100. If the system is in a locked state as depicted in FIG. 4, and the counterweight pendulum rod 5 cannot be pulled down any further, then the user can pull downward on the pull cords 11 (the unlocking pull tassel 6) at the closed end. Such a pulling force will similarly form an unlocking angle θ that produces an unlocking effect via transmission through the pull cords 11, as depicted in FIG. 5, after which the system enters the state as depicted in FIG. 6, enabling the system to rewind the curtain 100 and achieve the unlocking objective.

The window curtain set used in the present invention is primarily a device provided with pull cords. The operating length of the pull cords is greater than the opening length of the curtain, and enables adding an additional unlock travel distance. During operation, the user operates a counterweight pendulum rod fitted to the window curtain set to open the curtain. In a situation whereby it is necessary to add to the unlock travel distance when the curtain has already been opened to the limit, and the curtain can no longer be pulled downward any further, then the length of the unlock travel distance is used, whereupon the user is able to apply a downward force to an unlocking pull tassel, causing a downward inching motion thereof, which causes the system to enter an unlocking operation as depicted in FIG. 5, and enables the system to achieve the automatic rewinding objective as depicted in FIG. 6. The design of the present invention has not been previously disclosed in the curtain industry, and thus earnestly request the patent examiners to examine in detail and approve this patent application at the earliest convenience.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An unlocking assembly for feedback window curtain set, comprising:
a winding unit axially installed to a top horizontal rail;
a winding shaft, wherein an axis of the winding shaft is superimposed on the winding unit, and is in a linkage relationship with the winding unit;
a locking device, wherein an axis of the locking device is superimposed on the winding unit, and effects a rotation restriction on the winding shaft;
a set of pull cords, the winding shaft winds and releases the pull cords;
a curtain, wherein an upper end of the curtain is joined to the top horizontal rail, a lower end of the curtain is joined to a counterweight pendulum rod, and the pull cords are used to release the counterweight pendulum rod;
wherein an operating length of the pull cords is greater than an operating length of the curtain, thereby enabling the pull cords to add to an unlock mechanism.

2. The unlocking assembly for feedback window curtain according to claim 1, wherein the counterweight pendulum rod is hollow, two sides of an upper portion of the counterweight pendulum rod is respectively provided with slip holes, and a center of the lower portion of the counterweight pendulum rod is provided with a centralizing hole; free ends of the pull cords pass through the slip holes, wherein the free ends that have passed through the centralizing hole and exposed to an outside are joined together using an unlocking pull tassel.

3. The unlocking assembly for feedback window curtain according to claim 2, wherein cord sections of the pull cords that have passed through the slip holes and the centralizing hole are fitted with fastening stops.

4. The unlocking assembly for feedback window curtain according to claim 3, wherein the fastening stops include a front fastening stop and a rear fastening stop.

5. The unlocking assembly for feedback window curtain according to claim 2, wherein an extension cord extends and is joined to a lower end of the unlocking pull tassel.

6. The unlocking assembly for feedback window curtain according to claim 1, wherein an underside of the counterweight pendulum rod is fitted with an independent additional extension cord.
